(19) United States
(12) Patent Application Publication
(10) Pub. No.: US 2006/0289107 A1
(43) Pub. Date: Dec. 28, 2006

(54) Wallpaper border holder/positioning device

(76) Inventor: Dominick Summa, Olyphant, PA (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 11/168,643

(22) Filed: Jun. 28, 2005

(51) Int. Cl. B32B 37/00; E04F 13/00; B44C 7/00; B32B 37/12

(52) U.S. Cl. 156/71; 156/574; 156/577

(57) ABSTRACT

A device and method for aiding in the application of a wallpaper border material to a receiving surface. The device includes a body having at least one suction cup attached to the body for removably mounting the device to a first receiving surface and a spool receiver disposed on the body, the spool receiver having a spindle for holding a roll of wallpaper border material.

### BACKGROUND OF THE INVENTION

1. Field of Invention

This invention relates to a device for supporting, positioning and applying a roll of wallpaper border material on a structural surface.

2. Description OF Related Art

Wallpaper border material and other wall coverings conventionally come in cylindrical rolls. Applying wallpaper border material is often an awkward task sometimes requiring two persons to unroll the wallpaper border material from the roll and apply it to a wall. For example, one person may have to hold the roll and simultaneously move it from one section of the wall in the same direction as another person who is applying the strip of wallpaper border material to the wall.

Devices of various descriptions for aiding in the application of wallpaper border material are known. In this regard, reference is made to U.S. Pat. No. 5,125,609 (U.S. Cl. 248/216.1) which issued to Demeo on Jun. 30, 1992; U.S. Pat. No. 5,478,432 (U.S. Cl. 156/574) which issued to Vester on Dec. 26, 1995; and U.S. Pat. No. 5,743,485 (U.S. Cl. 242/597.7) which issued to Martorelli et al. on Apr. 28, 1998.

The Demeo patent relates to a device for holding a roll of wall covering vertically while a strip of wall covering is being applied to a wall.

The Vester patent relates to a device for installing wallpaper.

The Martorelli et al. patent relates to a wallpaper border-holding tool that is readily self-attachable to a wall surface, for supporting a roll of wallpaper border.

Previous inventions have used spikes to temporarily affix wallpaper border applicators to receiving surfaces. The present invention, with its use of suction cups, is an improvement over the aforementioned prior art devices as will be described below. Such prior art devices damage the surfaces where wallpaper borders are to be applied by leaving holes or other perforations. Moreover, if the surfaces are plaster the spikes may deteriorate the plaster surface by causing portions of plaster to chip and to fall out. The present invention, provides a device which, when used does not cause damage to the receiving surface to which wallpaper border material is applied. Furthermore, the present invention is useful in situations where it is impossible or impractical to use spikes, e.g., metal or glass surfaces, or other fragile surfaces. Furthermore still, the use of suction cups is more convenient and economical than spikes as suction cups are inexpensive and are easily replaceable compared to having to replace an entire device should a spike become damaged.

All references cited herein are incorporated herein by reference in their entireties.

### BRIEF SUMMARY OF THE INVENTION

The present invention contemplates a device for aiding in the application of a wallpaper border material to a receiving surface. The present invention includes a body having at least one suction cup attached to the body for removably mounting the device to a first receiving surface and a spool receiver disposed on the body, the spool receiver having a spindle for holding a roll of wallpaper border material. Preferably, the device includes a plurality of suction cups used for removably mounting the device to the first receiving surface. Preferably still, the device also includes at least one suction cup attached to the upper distal end of the body for removably mounting the body to a second receiving surface such as a ceiling that is generally perpendicular to the first receiving surface. Optionally, the spool receiver can include a platform on which the roll of wallpaper border material can rest. Optionally, the device can include a link disposed on the body to support the spool receiver. Additionally, the link can optionally be adjustable along the vertical axis of the body. Optionally, the body may be in the shape of a handle.

Also contemplated by the present invention is a method for applying wallpaper border material to a receiving surface comprising the steps of: providing a body having at least one suction cup attached to the body for removably mounting the device to a first receiving surface and optionally having at least one suction cup attached to the body for removably mounting the device to a second receiving surface; providing a spool receiver disposed on the body, the spool receiver having a spindle for holding a roll of wallpaper border material; loading a roll of wallpaper border material onto the spool receiver; placing the at least one suction cup for removably mounting the device to a first receiving surface onto the first receiving surface such that the device is attached to the first receiving surface; optionally placing the at least one suction for removably mounting the device to a second receiving surface onto the second receiving surface such that the device is attached to the second receiving surface; rolling the wallpaper border material which has been loaded onto the spindle receiver, away from the body; and applying the wallpaper border material to the first receiving surface using an adhesive previously applied to pre-moistened, prepasted border material or using a separate adhesive for non-prepasted border material.

### BRIEF DESCRIPTION OF SEVERAL VIEWS OF THE DRAWINGS

The invention will be described in conjunction with the following drawings in which like reference numerals designate like elements and wherein:

FIG. 1 is an elevation view showing a fragment of a wall and a device for aiding in the application of wallpaper border material, according to one preferred embodiment of the invention;

FIG. 2 is an isometric view of the device of FIG. 1; and

FIG. 3 is a cross-sectional view of the device of FIG. 1, taken substantially along lines 3-3 of FIG. 1.

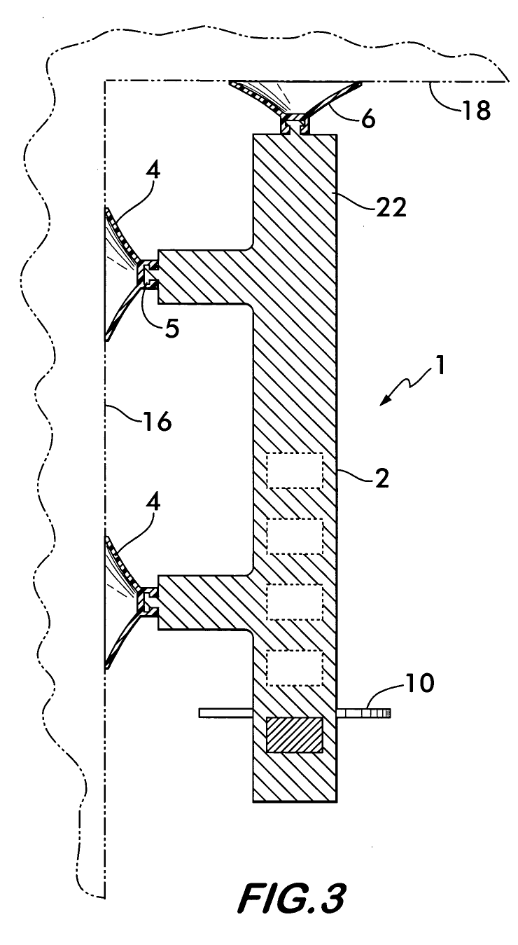

### DETAILED DESCRIPTION OF THE INVENTION

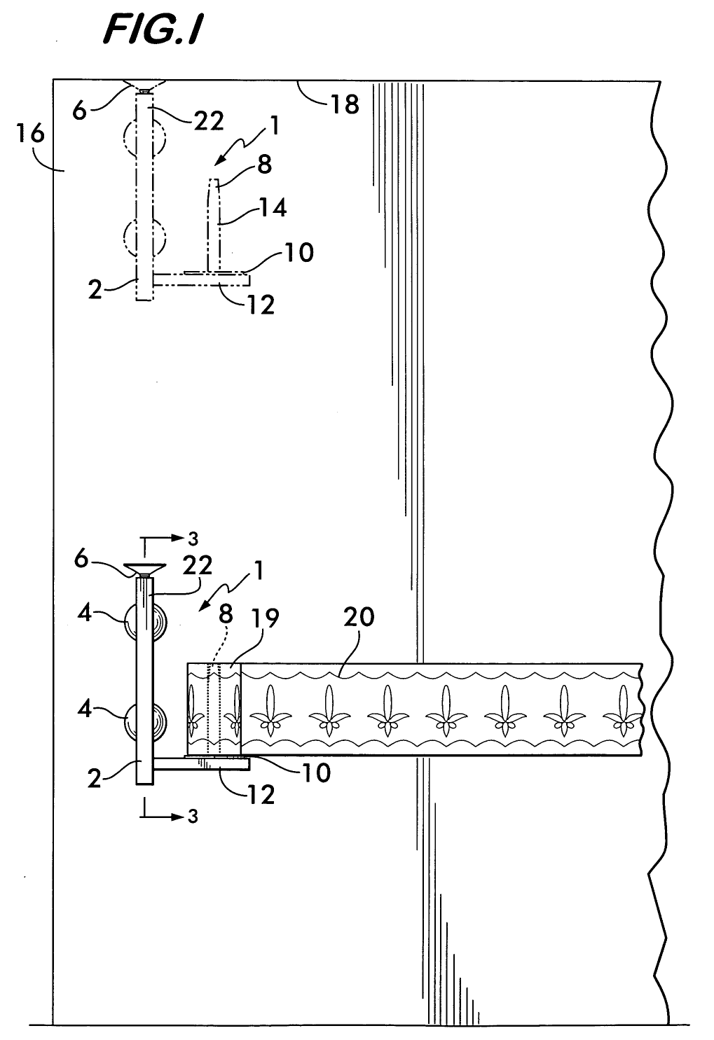

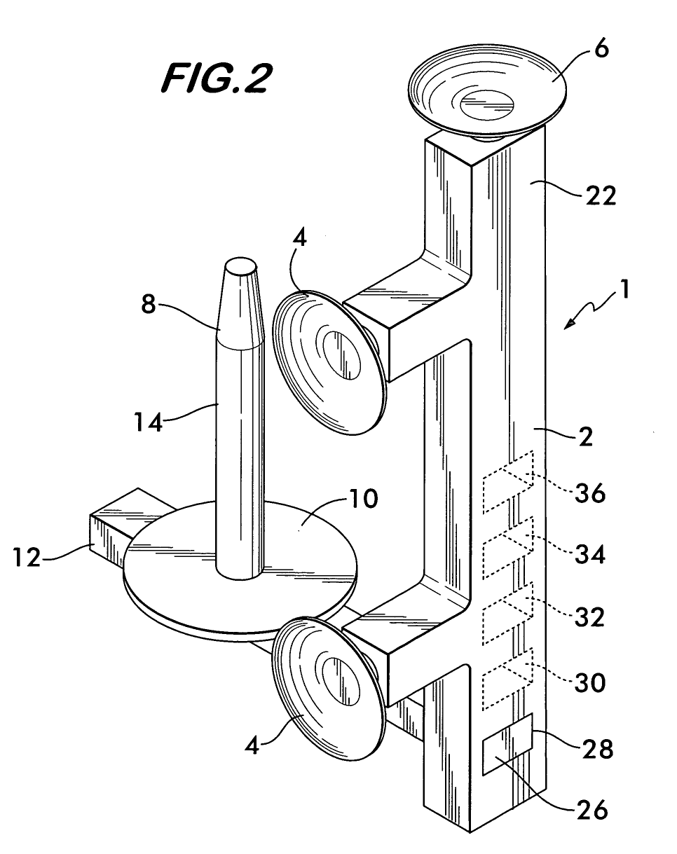

Referring now to the drawing figures wherein like part numbers refer to like elements throughout the several views, there is shown in FIGS. 1 and 2 a device for aiding the application of wallpaper border material in accordance with a preferred embodiment of the present invention.

With reference to FIG. 2, the device 1 includes a body 2, for example, a pair of wall suction cups 4 for attaching the device to a first receiving surface, such as a wall, and for example, one ceiling suction cup 6 for attaching the device to a second receiving surface, such as a ceiling. The device 1 further includes a spool receiver 14 which is joined to the body 2 by a link 12. The spool receiver 14 includes a spindle 8 for holding a roll of wallpaper border material 20 and a platform 10 on which the roll of wallpaper border material can rest.

In use, the device can be positioned at the upper portion of a wall 16 with the ceiling suction cup 6 flush with the ceiling. FIG. 1 shows a broken line depiction of the device attached to the upper portion of a wall 16 by wall suction cups 4 and also attached to the ceiling 18 by the ceiling suction cup 6 on the upper distal end 22 of the body 2. Also, separately depicted in FIG. 1, the device 1 is shown being used for applying a roll 19 of wallpaper border material 20 along the wall 16. Once the device 1 is positioned as desired, the wallpaper border material 20 can then be unrolled and applied to the wall 16 using an adhesive previously applied to pre-moistened, prepasted border material or a separate adhesive for non-prepasted border material.

After the wallpaper border material 20 has been secured to the wall 16 and ceiling 18, the user can simply detach the device 1 from the wall 16 and ceiling 18 by breaking the suction applied by wall suction cups 4 and/or ceiling suction cup 6. The device 1 can then be positioned further along on the wall 16 or on a different wall, and a different portion of wallpaper border material 20 can be applied. It is possible to move the device 1 from either left to right or right to left. However, with the embodiment as shown in FIG. 1, it is preferable to move from right to left since the roll 19 of wallpaper border material 20 is to the left of the body 2.

It should be appreciated that the link 12 could optionally be removably affixed to the body 2 such that the link 12 and spool receiver 14 can be positioned on either the left or the right side of the body 2. Such removable positioning of the link 12 on either the left or the right side of the body 2 could be accomplished by any number of means. For example, the link 12 might be positioned by fitting an integral pin 26 into an aperture 28 that runs through the horizontal axis of the body 2. By removing the integral pin 26 from the aperture 28 it can then be reinserted into the aperture 28 however this time on the opposite side of the body 2 on which the link 12 was previously positioned.

It should also be appreciated that the link 12 could optionally be removably positioned along the vertical axis of the body 2 such that the spool receiver 14 would be either closer to or farther from a ceiling. Such removable positioning of the link 12 along the vertical axis of the body 2 could be accomplished by any number of means. For example, a series of optional apertures 30, 32, 34, and 36 could be made along the vertical axis of the body 2 such that the link 12 could removably join to the body 2 by fitting an integral pin 26 into any one of the apertures as represented in FIG. 2 with hatched lines. Other possible examples include removably affixing the link 12 to the body 2 by the use of screws, screws and brackets, or other means of fastening (not shown).

It should also be appreciated that the device 1 does not necessarily need to include the link 12. In such an embodiment the spool receiver 14 is attached directly to the body 2.

It will be evident that a device 1 of the present invention could be made with only one wall suction cup 4 used for removably mounting the device to a wall 16. However, a single wall suction cup 4 may not provide a sufficiently stable mounting under certain circumstances because the body 2 could pivot or twist around the axis of the stem 5 of a single wall suction cup 4. The use of two wall suction cups 4 for removably mounting the device 1 to a wall 16 substantially reduces the possibility of such twisting of the body 2. Two wall suction cups 4 for removably mounting the device to a wall 16 are adequate for the purposes of this invention, but it is evident that three or more suction cups could be used.

It will also be evident that a device 1 of the present invention could be made without a ceiling suction cup 6 used for removably mounting the device to a ceiling 18. However, the use of a ceiling suction cup 6 for removably mounting the device 1 to a ceiling 18 substantially increases the stability of the device 1. One ceiling suction cup 6 for removably mounting the device 1 to a ceiling 18 may be adequate for the purposes of this invention, but it is evident that two or more suction cups could also be used.

The body 2 of the device 1 may optionally be in the shape of a handle. A handle shape allows for the user to attach and detach the device 1 to and from a receiving surface with greater ease. Additionally, a handle shape lessens the chance of scraping or otherwise harming the user's hands and fingers when attaching the device 1 to a receiving surface.

The device 1 can be made of any suitable material, however it is preferable to use plastic as it is a light weight material. A light weight material not only allows the user to move the device 1 with greater ease, but also allows for less strain against the suction between the suction cups 4, 6 and receiving surfaces. Less strain against the suction makes it possible for the device 1 to be continuously attached to receiving surfaces for longer periods of time in certain situations.

There are numerous ways to mount the suction cups 4, 6 to the device 1 any of which may be used with the present invention (See, e.g., U.S. Pat. No. 5,148,769). For example, it will be apparent that the suction cups 4, 6 may be attached to the body 2 of the device 1 by adhesive, screws, nails, ball and socket connections, or any other method described in the prior art.

A variety of suction cups types may be used in the present invention. For example, a suction cup having mushroom cap stems may be preferred for certain applications (See, e.g., U.S. Pat. No. 6,053,356). Alternatively, suction cups that allow for quicker release than standard suction cups may be used in certain instances because they have a tab that can be pulled allowing the suction to break more easily (See, e.g., U.S. Pat. No. 6,443,388 B1).

With the present invention in mind, applying wallpaper border material to a receiving surface may be accomplished by a method comprising the steps of: providing a body having at least one suction cup attached to the body for removably mounting the device to a first receiving surface and optionally having at least one suction cup attached to the body for removably mounting the device to a second receiving surface; providing a spool receiver disposed on the body, the spool receiver having a spindle for holding a roll of wallpaper border material; loading a roll of wallpaper border material onto the spool receiver; placing the at least one suction for removably mounting the device to a first receiving surface onto the first receiving surface such that the device is attached to the first receiving surface; optionally placing the at least one suction for removably mounting the device to a second receiving surface onto the second receiving surface such that the device is attached to the second receiving surface; rolling the wallpaper border material, which has been loaded onto the spindle receiver, away from the body; and applying the wallpaper border material to the first receiving surface using an adhesive previously applied to pre-moistened, prepasted border material or a separate adhesive for non-prepasted border material.

While the invention has been described in detail and with reference to specific embodiments thereof, it will be apparent to one skilled in the art that various adaptations and modifications can be made therein without departing from the spirit and scope thereof.

What is claimed is:

1. A device for aiding in the application of a wallpaper border material to a receiving surface, comprising:
a body having at least one suction cup attached to the body for removably mounting the device to a first receiving surface; and
a spool receiver disposed on the body, the spool receiver having a spindle for holding a roll of wallpaper border material.

2. A device according to claim 1, including a plurality of suction cups used for removably mounting the device to the first receiving surface.

3. A device according to claim 1, wherein there is at least one suction cup attached to an upper distal end of the body for removably mounting the body to a second receiving surface that is generally perpendicular to the first receiving surface.

4. A device according to claim 1, including a plurality of suction cups for removably mounting the body to the first receiving surface and including at least one suction cup attached to an upper distal end of the body used for removably mounting the body to a second receiving surface.

5. A device according to claim 1, wherein the spool receiver also includes a platform on which the roll of wallpaper border material can rest.

6. A device according to claim 1, including a link disposed on the body to support the spool receiver.

7. A device according to claim 6, wherein the link is adjustable along a vertical axis of the body.

8. A device according to claim 4, wherein the spool receiver also includes a platform on which the roll of wallpaper border material can rest.

9. A device according to claim 4, including a link disposed on the body to support the spool receiver.

10. A device according to claim 9, wherein the link is adjustable along a vertical axis of the body.

11. A device according to claim 10, wherein the spool receiver also includes a platform on which the roll of wallpaper border material can rest.

12. A device according to claim 1, wherein the body is in the shape of a handle.

13. A device according to claim 11, wherein the body is in the shape of a handle.

14. A method for applying wallpaper border material to a receiving surface comprising the steps of:
providing a body having at least one suction cup attached to the body for removably mounting the device to a first receiving surface;
providing a spool receiver disposed on the body, the spool receiver having a spindle for holding a roll of wallpaper border material;
loading a roll of wallpaper border material onto the spool receiver;
placing the at least one suction onto the first receiving surface such that the device is attached to the first receiving surface;
rolling the wallpaper border material, which has been loaded onto the spindle receiver, away from the body; and
applying the wallpaper border material to the first receiving surface using an adhesive already applied to pre-moistened, prepasted border material or a separate adhesive for non-prepasted border material.

15. A method for applying wallpaper border material to a receiving surface comprising the steps of:
providing a body having at least one suction cup attached to the body for removably mounting the device to a first receiving surface and having at least one suction cup attached to the body for removably mounting the device to a second receiving surface;
providing a spool receiver disposed on the body, the spool receiver having a spindle for holding a roll of wallpaper border material;
loading a roll of wallpaper border material onto the spool receiver;
placing the at least one suction cup for removably mounting the device to a first receiving surface onto the first receiving surface such that the device is attached to the first receiving surface;
placing the at least one suction cup for removably mounting the device to a second receiving surface onto the second receiving surface such that the device is attached to the second receiving surface;
rolling the wallpaper border material, which has been loaded onto the spindle receiver, away from the body; and applying the wallpaper border material to the first receiving surface using an adhesive already applied to pre-moistened, prepasted border material or a separate adhesive for non-prepasted border material.
